(19) United States
(12) Patent Application Publication
(10) Pub. No.: US 2008/0174173 A1
(43) Pub. Date: Jul. 24, 2008

(54) Brake control device for vehicle

(76) Inventors: Koichi Kokubo, Nagoya-shi (JP); Kazutoshi Yogo, Aichi-ken (JP)

Correspondence Address: BUCHANAN, INGERSOLL & ROONEY PC, POST OFFICE BOX 1404, ALEXANDRIA, VA, 22313-1404, US

(21) Appl. No.: 12/003,941

(22) Filed: Jan. 3, 2008

(30) Foreign Application Priority Data
Jan. 23, 2007 (JP) 2007-012483

(51) Int. Cl. B60T 13/122; B60T 13/16; B60T 8/40

(52) U.S. Cl. 303/116.1; 303/43

(57) ABSTRACT

A brake control device for a vehicle, which controls a pressure difference control valve and a pump provided at a main and a auxiliary conduits respectively to control a flow of brake fluid supplied from a master cylinder to a wheel cylinder, includes a determining step for determining whether or not to execute a brake control in an emergency situation, a first control step for controlling the pressure difference control valve to be in a pressure difference generating state and for controlling the pump to supply the brake fluid to the main conduit through the auxiliary conduit, and a second control step for controlling the pressure difference control valve to be in a fluid communicating state, and for controlling the pump to supply the brake fluid to the main conduit through the auxiliary conduit, wherein the second control means is executed before the first control means in the emergency situation.

### CROSS REFERENCE TO RELATED APPLICATIONS

This application is based on and claims priority under 35 U.S.C. § 119 to Japanese Patent Application 2007-012483, filed on Jan. 23, 2007, the entire content of which are incorporated herein by reference.

### FIELD OF THE INVENTION

The present invention relates to a brake control device for a vehicle, by which fluid pressure within a wheel cylinder is rapidly increased when a brake operation in an emergency situation is conducted.

### BACKGROUND

Known brake control systems for a vehicle (hereinafter, referred to as a brake control system) suck brake fluid from a master cylinder (hereinafter, referred to as a M/C) by means of a pump, and the known brake control systems discharge the brake fluid to a wheel cylinder (hereinafter referred to as a W/C) in order to increase pressure within the W/C (hereinafter, referred to as W/C pressure). For example, a known brake control system disclosed in JP1998152041A determines that a brake control in an emergency situation needs to be executed, for example, when a driver suddenly and quickly depresses a brake pedal. Then the known brake control system disclosed in JP1998152041A increases the W/C pressure so as to exceed pressure of the M/C (hereinafter, referred to as M/C pressure) by applying pressure to the pump for the brake control in the emergency situation.

Manners on how to transmit brake fluid pressure when the brake control in the emergency situation is required will be described below in accordance with FIG. 3. As illustrated in FIG. 3, when the known brake control system determines that the brake control in the emergency situation is required, the known brake control system controls a pressure difference control valve 16 (36) to be in a pressure difference generating state so that the W/C pressure is increased to exceed the M/C pressure. The pressure difference control valve 16 (36) is provided within the conduit A (E) that connects a M/C 13 and W/Cs 14 and 15 (34 and 35). Then, the known brake control system disclosed in JP1998152041 controls the W/C pressure so as to exceed the M/C pressure by sucking the brake fluid existing within the M/C 13 by means of a pump 19 (29) and then by discharging the brake fluid to the W/Cs 14 and 15 (34 and 35). Additionally, the pressure difference generating state indicates a state in which the W/C pressure differs from the M/C pressure.

As mentioned above, by increasing the W/C pressure by means of the pump 19 (39), the know brake control system disclosed in JP1998152041A rapidly applies pressure to the W/Cs 14 and 15 (34 and 35) and further, the know brake control system disclosed in JP1998152041A applies larger pressure to the W/Cs 14 and 15 (34 and 35). Still, there is room for the brake control system to be improved so that the W/C pressure of each of the W/Cs 14 and 15 (34 and 35) is more rapidly increased.

The above-mentioned known art is described with the brake control system having a brake assist function as an example. The brake control system having the brake assist function increases the W/C pressure to exceed the M/C pressure for the brake operation in the emergency situation. Furthermore, the brake control in the emergency situation may be achieved by increasing the W/C pressure to the same level as the M/C pressure more rapidly than a case where a normal braking operation is conducted, instead of by increasing the W/C pressure to exceed the M/C pressure. However, even when the brake control system rapidly increases the W/C pressure to the same level as the M/C pressure for the brake control in the emergency situation, sill, there is room for the brake control system to be improved so that the W/C pressure of each of the W/Cs 14 and 15 (34 and 35) is rapidly increased.

A need thus exists to provide a brake control apparatus for a vehicle which is not susceptible to the drawback mentioned above.

### SUMMARY OF THE INVENTION

According to an aspect of the present invention, a brake control device for a vehicle for controlling a pressure difference control valve provided at a main conduit and a pump provided at an auxiliary conduit in order to control a flow of brake fluid supplied from a master cylinder to a wheel cylinder provided at each of plural wheels, the master cylinder and the wheel cylinder are connected by the main conduit and the auxiliary conduit, the brake control device for the vehicle includes, a determining means for determining whether or not to execute a brake control in an emergency situation, a first control means for controlling the pressure difference control valve to be in a pressure difference generating state and for controlling the pump in order to supply the brake fluid between the pressure difference control valve and the wheel cylinder through the auxiliary conduit, and a second control means for controlling the pressure difference control valve to be in a fluid communicating state, and for controlling the pump in order to supply the brake fluid between the pressure difference control valve and the wheel cylinder through the auxiliary conduit, wherein the second control means is executed before the first control means is executed when the first determining means determines to execute the brake control in the emergency situation.

According to another aspect of the present invention, a brake control device for a vehicle for controlling a pressure difference control valve provided at a main conduit and a pump provided at an auxiliary conduit in order to control a flow of brake fluid supplied from a master cylinder to a wheel cylinder provided at each of plural wheels, the master cylinder and the wheel cylinder are connected by the main conduit and the auxiliary conduit, the brake control device for the vehicle includes a first determining means for determining whether or not to execute a brake control in an emergency situation, and a control means for controlling the pressure difference control valve to be in a fluid communicating state and for controlling an open/close control valve, which is provided between the pump and the master cylinder, to be in the fluid communicating state within the auxiliary conduit, when the determining means determines to execute the brake control in the emergency situation.

According to a further aspect of the present invention, a brake control device for a vehicle for controlling a pressure difference control valve provided at a main conduit and a pump provided at an auxiliary conduit in order to control a flow of brake fluid supplied from a master cylinder to a wheel cylinder provided at each of plural wheels, the master cylinder and the wheel cylinder are connected by the main conduit and the auxiliary conduit, the brake control device for the vehicle includes a determining means for determining whether or not to execute a brake control in an emergency situation, and a control means for driving the pump in order to suck and discharge the brake fluid stored within a pressure modulating reservoir connected to the auxiliary conduit, when the determining means determines to execute the brake control in the emergency situation.

### BRIEF DESCRIPTION OF THE DRAWINGS

The foregoing and additional features and characteristics of the present invention will become more apparent from the following detailed description considered with reference to the accompanying drawings, wherein:

FIG. 1 is a diagram illustrating an entire configuration of a brake control system related to a first embodiment of the present invention;

FIG. 2 is a flowchart illustrating a brake control process when a brake control in an emergency situation is executed by an ECU;

FIG. 3 is a simplified diagram illustrating a conduit configuration of the brake control system of a known art and the embodiment for describing routes of brake fluid being supplied when the brake control in the emergency situation and a normal braking operation are conducted;

FIG. 4 is a timing chart illustrating changes of M/C pressure and W/C pressure over time from an initial time when a braking operation is started;

FIG. 5 is a flowchart illustrating the brake control in the emergency situation executed by the ECU in relation to a second embodiment of the present invention;

FIG. 6 is a timing chart illustrating changes of the M/C pressure and the W/C pressure over the initial time from the time when the braking operation is started;

FIG. 7 is a diagram illustrating an entire configuration of the brake control system in relation to a third embodiment of the present invention;

FIG. 8 is a flowchart illustrating the brake control in the emergency situation executed by the ECU;

FIG. 9 is a simplified diagram illustrating the conduit configuration of the brake control system for describing the routes of the brake fluid being supplied when the brake control in the emergency situation and the brake control for the normal braking operation are conducted;

FIG. 10 is a flowchart illustrating the brake control process in the emergency situation executed by the ECU; and

FIG. 11 is a timing chart illustrating the changes of the M/C pressure and the W/C pressure over the time from the initial time when the braking operation is started.

### DETAILED DESCRIPTION

Embodiments of a brake control device for a vehicle related to the present invention will be described below in accordance with the attached drawings. In the embodiments below, identical reference numerals designate identical or equivalent elements through several drawings.

### First Embodiment

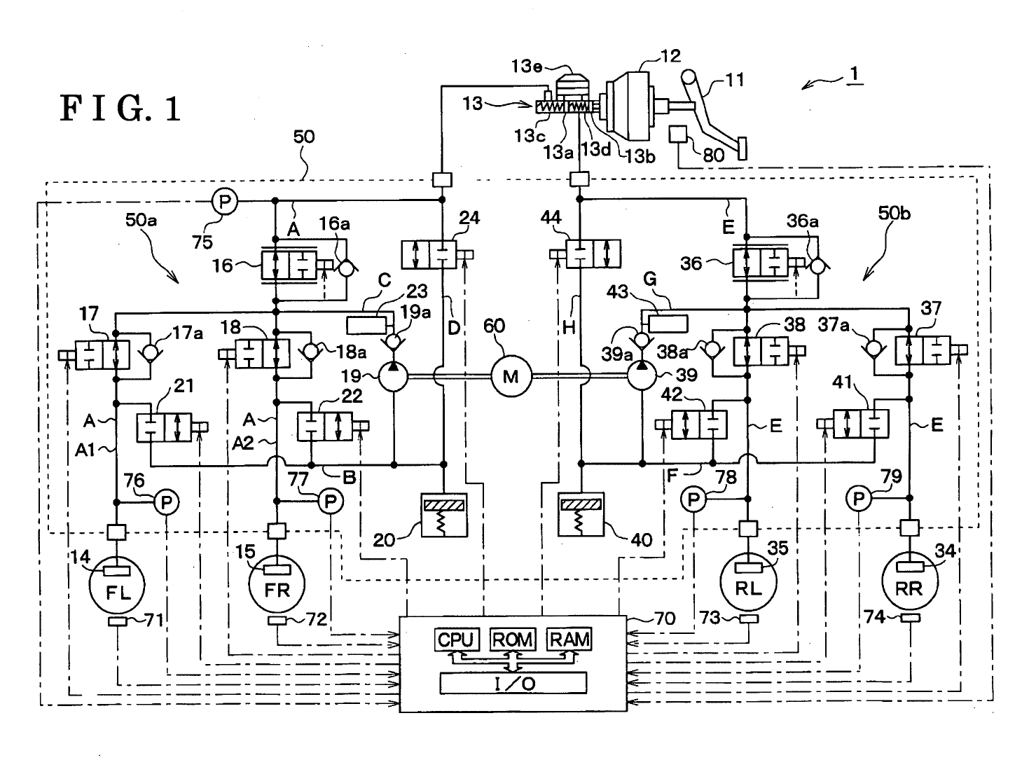

A first embodiment of the present invention will be described below. FIG. 1 is a diagram illustrating an entire configuration of a brake control system 1 that executes a brake control in an emergency situation when necessary.

As illustrated in FIG. 1, the brake control system 1 includes a brake pedal 11, a booster 12, a master cylinder 13 (hereinafter referred to as a M/C 13), wheel cylinders 14, 15, 34 and 35 (hereinafter referred to as W/Cs 14, 15, 34 and 35), a brake fluid pressure control actuator 50 (hereinafter referred to as a brake ACT 50) and an electric control unit 70 (hereinafter referred to as an ECU 70).

The brake pedal 11 is connected to the booster 12 and to the M/C 13. The booster 12 and the M/C 13 function as a brake fluid pressure generating source. The brake pedal 11 functions as a braking operation member, which is depressed by a driver to apply braking force to the vehicle. When the brake pedal 11 is depressed by the driver, depressing force applied to the brake pedal 11 is boosted by the booster 12, and then, master pistons 13a and 13b provided at the M/C 13 are pressed by the boosted depressing force. The M/C includes a primary chamber 13c and a secondly chamber 13d. The master piston 13b is provided between the secondary chamber 13d and the booster 12. The master piston 13a divides the primary chamber 13c from the secondary chamber 13d. Therefore, the same level of pressure of the M/C (hereinafter referred to as M/C pressure) is generated at the primary chamber 13c and the secondary chamber 13d by the master pistons 13a and 13b being pressed by the boosted depressing force. Further, the M/C is so configured that the M/C pressure is transmitted to each of the W/Cs 14, 15, 34 and 35 through the brake ACT 50.

The M/C 13 includes a master reservoir 13e that has passages for communicating with the primary chamber 13c and the secondary chamber 13d. The master reservoir 13e supplies brake fluid to the primary and the secondary chambers 13c and 13d of the M/C 13 via the passages, and the master reservoir 13e stores excess brake fluid within the M/C 13.

The brake ACT 50 is configured to include a first conduit system 50a and a second conduit system 50b so as to form a front-rear dual circuit. In the front-rear dual circuit system, the front wheels are connected to the M/C via the first conduit system 50a and the rear wheels are connected to the M/C via the second conduit 50b. More specifically, the first conduit system 50a controls brake fluid pressures applied to a front left wheel FL and a front right wheel FR. The second conduit system 50b controls the brake fluid pressures applied to a rear left wheel RL and a rear right wheel RR.

Configurations and functions of the first and the second conduit system 50a and 50b are described below with taking the first conduit system 50a as an example. The second conduit system 50b has the same configuration and function as the first conduit system 50a, hence, detailed description of the second conduit system 50b is omitted.

The first conduit system 50a includes a conduit A that functions as a main conduit through which the M/C pressure is transmitted to the W/Cs 14 and 15. The W/C 14 is provided at the front left wheel FL, and the W/C 15 is provided at the front right wheel FR. Hence, the W/C pressure is generated at each of the W/Cs 14 and 15 through the conduit A.

Additionally, the conduit A includes a first pressure difference control valve 16 having a well-known configuration. The first pressure difference control valve 16 is configured with an electromagnetic valve. The first pressure difference control valve 16 is controlled to be in a fluid communicating state, in a pressure difference generating state or in an interrupting state. When the first pressure difference control valve 16 is in the fluid communicating state, flow of the brake fluid in the conduit A is established, or fluid communication between the M/C 13 and the W/Cs 14 and 15 is established. When the first pressure difference control valve 16 is in the pressure difference generating state, pressure difference between the M/C pressure and the W/C pressure of each of the W/Cs 14 and 15 is generated. When the first pressure difference control valve 16 is in the interrupting state, the flow of the brake fluid in the conduit A is interrupted by the pressure difference control valve 16, or the fluid communication between the M/C 13 and the W/Cs 14 and 15 is interrupted by the first pressure difference control valve 16. The configuration of the well-known pressure difference control valve is the same as the one described in JP1998152041A, hence the detailed configuration of the first pressure difference valve 16 is omitted in this embodiment. The first pressure difference control valve 16 linearly adjusts a pressure difference value depending on a value of an electric current supplied to a solenoid coil. Further, the first pressure difference control valve 16 is controlled to be in the interrupting state when the electric current value is increased up to a predetermined value. The first pressure difference control valve 16 is controlled to be in the fluid communicating state for normal braking operation, and the first pressure difference control valve 16 is controlled to be in the pressure difference generating state or in the interrupting state when electric power is supplied to the solenoid coil for a brake control in the emergency situation. The electric power is supplied to the solenoid coil when the driver depresses the brake pedal 11 quickly and firmly to conduct the brake operation in the emergency situation. When, for example, the W/C pressure value, which corresponds to the W/C pressure of one of the W/Cs 14 and 15, becomes larger than the M/C pressure value, which corresponds to the M/C pressure, for a predetermined value under a condition where the first pressure difference control valve 16 is controlled to be in the pressure difference generating state, the brake fluid flows in a direction only from the W/Cs 14 and 15 to the M/C 13. Hence, generally, the W/C pressure values of the W/Cs 14 and 15 are maintained so as not to exceed the M/C pressure value of the M/C 13 for the predetermined value in order to protect each conduit.

The conduit A is branched into a conduit A1 and a conduit A2 at a downstream side closer to the W/Cs 14 and 15 from the first pressure difference control valve 16. A pressure increase control valve 17 is provided at the conduit A1 for controlling increase of the brake fluid pressure applied to the W/C 14. A pressure increase control valve 18 is provided at the conduit A2 for controlling the increase of the brake fluid pressure applied to the W/C 15.

Each of the pressure increase control valves 17 and 18 is configured with an electromagnetic valve, and further each of the pressure increase control valves 17 and 18 functions as a two-position switchover valve that is controlled to be in the fluid communicating state or in the interrupting state. For example, when the pressure increase control valve 17 is in the fluid communicating state, the flow of the brake fluid within the conduit A1 is established. Further, for example, when the pressure increase control valve 17 is in the interrupting state, the flow of the brake fluid within the conduit A1 is interrupted. When the pressure increase control valves 17 and 18 are controlled to be in the fluid communicating states, the M/C pressure or a brake fluid pressure generated by discharging the brake fluid from the pump 19, which will be described below, is applied to the W/Cs 14 and 15.

Additionally, when the driver operates the normal braking operation by depressing the brake pedal 11, the first pressure difference control valve 16 and the pressure increase control valves 17 and 18 are normally controlled to be in the fluid communicating states.

Further, a pressure increasing valve 16a, safety valves 17a and 18a are provided at the first pressure difference control valve 16, the pressure increase control valves 17 and 18 respectively. The safety valve 17a is arranged so as to be in parallel to the pressure increase control valve 17, and similarly, the safety valve 18a is arranged so as to be in parallel to the pressure increase control valve 18. The pressure increasing valve 16a of the first pressure difference control valve 16 is provided for transmitting the M/C pressure to the W/Cs 14 and 15 when the driver depresses the brake pedal 11 under a condition where the first differential control valve is controlled to be in the pressure difference generating state or in the interrupting state. Additionally, the safety valves 17a and 18a are provided at the pressure increase control valves 17 and 18 respectively for decreasing the W/C pressures of the front left wheel FL and the front right wheel FR so as to correspond to a driver's operation of releasing the brake pedal 11 while the pressure increase control valves 17 and 18 are controlled to be in the interrupting state, especially under a condition where an anti-lock brake system (ABS) is executed.

A conduit B, which functions as a pressure decreasing conduit, connects a reservoir 20 with points on the conduit A between the pressure increasing valves 17, 18 and the W/Cs 14, 15. Pressure decreasing control valves 21 and 22, each of which is configured with an electromagnetic valve, are provided at the conduit B. The pressure decreasing control valves 21 and 22 are normally controlled to be in the interrupting state when the normal braking operation is conducted by the driver.

A conduit C, which functions as a reflux conduit, is provided so as to connect the reservoir 20 and the conduit A that functions as the main conduit. The self-suction pump 19 is provided at the conduit C so that the pump 19 sucks and discharges the brake fluid towards the M/C 13 or towards the W/Cs 14 and 15 from the reservoir 20. Further, the pump 19 is driven by a motor 60.

A safety valve 19a is provided in the vicinity of an outlet of the pump 19 so that high brake fluid pressure is not applied to the pump 19. Furthermore, a dumper 23 is provided at the conduit C in the vicinity of the outlet of the pump 19 in order to reduce pulsation of the brake fluid being discharged from the pump 19.

A conduit D, which functions as an auxiliary conduit, is provided so as to connect the reservoir 20 and the M/C 13. An open/close control valve 24, which is configured with an electromagnetic valve, is provided at the conduit D. The open/close control valve 24 functions as a two-position switch over valve that is controlled to be in the fluid communicating state or in the interrupting state. For example, when the open/close control valve 24 is controlled to be in the fluid communicating state, the flow of the brake fluid within the conduit D is established. Further, for example, when the open/close control valve 24 is controlled to be in the interrupting state, the flow of the brake fluid within the conduit D is interrupted. When current is not supplied to the open/close control valve 24, the open/close control valve 24 is controlled to be in the interrupting state, and when the current is supplied to the open/close control valve 24, the open/close control valve 24 is controlled to be in the fluid communicating state. Hence, the open/close control valve 24 controls the flow of the brake fluid within the conduit D to be either in the established state or in the interrupting state. When the open/close control valve 24 is controlled to be in the fluid communicating state, the brake fluid is sucked from the M/C 13 by means of the pump 19, and then the brake fluid is discharged to the conduit A in order to supply the brake fluid to the W/Cs 14 and 15 and then in order to increase the W/C pressures of the W/Cs 14 and 15 so as to be higher than the M/C pressure for the brake control in the emergency situation and the like.

As mentioned above, the second conduit system 50b has the same configuration as the first conduit system 50a. Hence, a second pressure difference control valve 36 and a pressure increasing valve 36a correspond to the first pressure difference control valve 16 and the pressure increasing valve 16a respectively. Third and fourth pressure increase control valves 37 and 38 and third and fourth safety valves 37a and 38a correspond to the pressure increase control valves 17 and 18 and the safety valves 17a and 18a respectively. Further, third and fourth pressure decreasing control valves 41 and 42 correspond to the pressure decreasing control valves 21 and 22 respectively. A reservoir 40 corresponds to the reservoir 20. A pump 39 corresponds to the pump 19. A dumper 43 corresponds to the dumper 23. An open/close control valve 44 corresponds to the open/close control valve 24. Conduits E, F, G and H correspond to the conduits A, B, C and D respectively. The configuration of the fluid pressure conduit of the brake control system 1 is configured as above.

Further, wheel speed sensors 71, 72, 73 and 74 are provided at the brake control system 1. The wheel speed sensors 71, 72, 73 and 74 are arranged so as to correspond to the front left wheel FL, the front right wheel FR, the rear left wheel RL and the rear right wheel RR respectively. Each of the wheel speed sensors 71, 72, 73 and 74 outputs a pulse signal to the ECU 70. The pulse signal from each of wheel speed sensors 71, 72, 73 and 74 has a number of pulses that is proportional to rotational speed, that is to say, wheel speed, of each of the front left wheel FL, the front right wheel FR, the rear left wheel RL and the rear right wheel RR.

Further, a M/C pressure sensor 75, W/C pressure sensors 76, 77, 78 and 79, and a stop light switch 80 are provided at the brake control system 1. Each of the W/C pressure sensors 76, 77, 78 and 79 detects the W/C pressure generated at each of the W/Cs 14, 15, 35 and 34 respectively. The M/C pressure sensor 75, the W/C pressure sensors 76, 77, 78 and 79 are included in a detecting means. The stop light switch 80 is turned on while the braking operation is operated, hence, a state of the braking operation whether the brake pedal 11 is depressed or not may be determined by using a state of the stop light switch 80. The detection signal of each of the W/C pressure sensors 76, 77, 78 and 79, and the stop light switch 80 is also inputted to the ECU 70.

The ECU 70 corresponds to the brake control device for the vehicle related to the present invention. The ECU 70 is configured with a well-known microcomputer that includes a central processing unit (CPU), a read-only memory (ROM), a random access memory (RAM), input-output (I/O) and the like. The ECU 70 receives, for example, the detection signals outputted from the wheel speed sensors 71, 72, 73, and 74, the W/C pressure sensors 76, 77, 78 and 79, and the stop light switch 80. Then, the ECU 70 executes processes relating to brake control including the brake control in the emergency situation by using the detection signals and by following programs memorized at the ROM and the like.

Current supply to the motor 60 that drives the control valves 16, 17, 18, 22, 24, 36, 37, 37, 41, 42 and 44 of the brake ACT 50 and the pumps 19 and 39 is controlled on the basis of a control signal outputted from the ECU 70. As a result, the W/C pressure generated at each of the W/Cs 14, 15, 34 and 35 is controlled by the ECU 70.

An operation of the brake control system 1 of the embodiment will be described below. According to the brake control system 1 having the above-mentioned configuration, the brake control system 1 may also execute the brake control such as the ABS control in addition to the brake control in the emergency situation. However, the ABS control does not directly relate to the present invention, hence a case where the brake control in the emergency situation is executed and a case where the brake control in the emergency situation is not executed, in other word, when the brake control for the normal braking operation is executed, will be descried below.

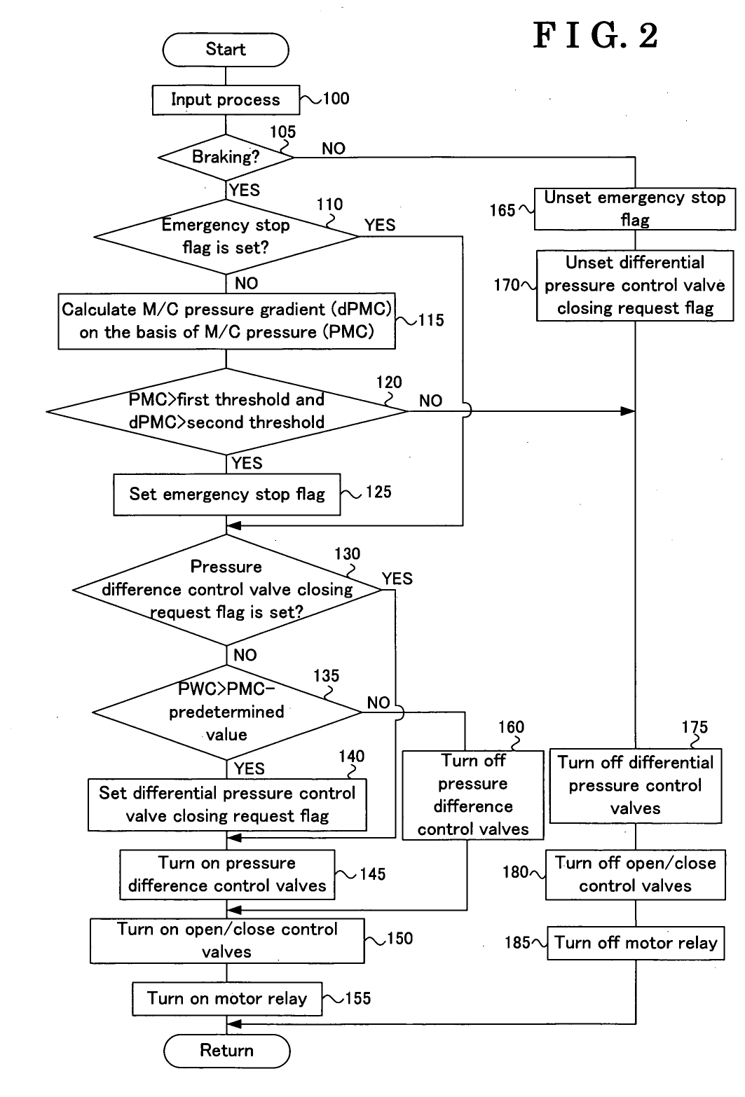

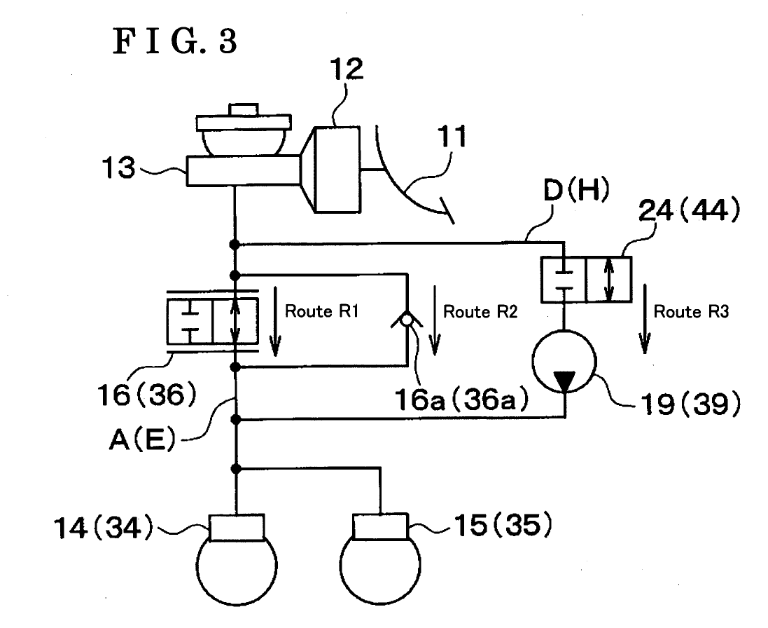

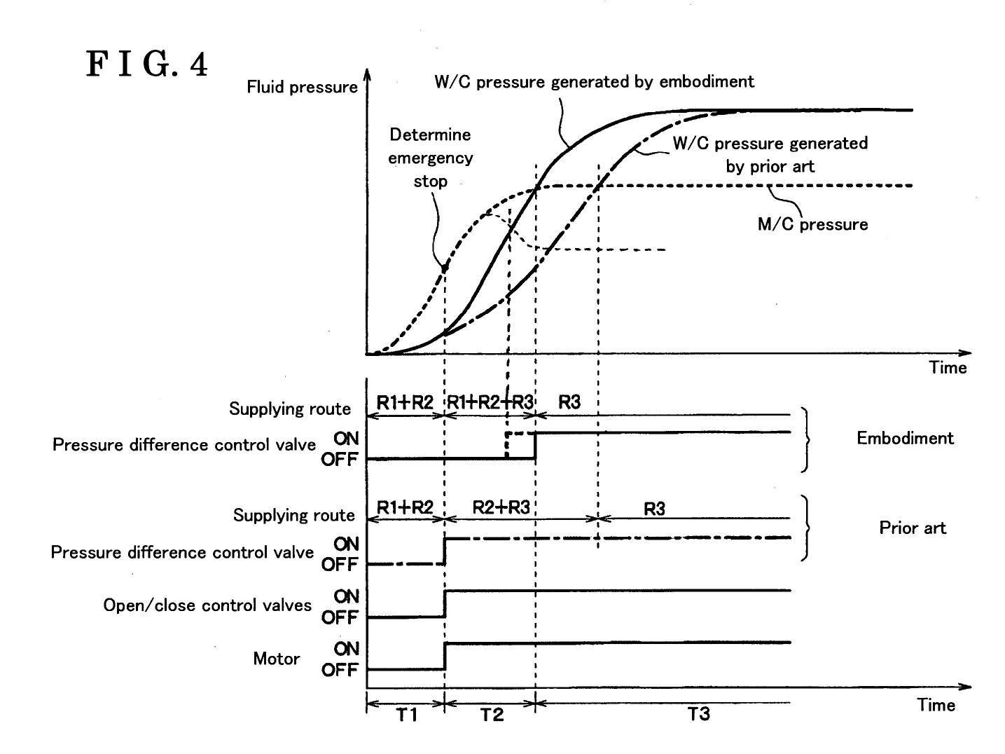

FIG. 2 is a flowchart illustrating a brake control process for the brake control in the emergency situation executed at the ECU 70. FIG. 3 is a simplified diagram illustrating the conduit configuration of the brake control system 1 for describing routes of the brake fluid being supplied when the driver operates the brake pedal 11 in order to conduct the normal braking operation and the brake operation in emergency situation. The brake fluid supplying routes for the second conduit system 50b are configured to be the same as the brake fluid supplying routes for the first conduit system 50b. Hence, FIG. 3 illustrates the routes through which the brake fluid is supplied in the first conduit system 50a as an example. The reference numerals and alphabets surrounded by the round brackets indicate the parts (the valves, the conduits and the wheels) of the second conduit system 50b that correspond to the parts (the valves, the conduits and the wheels) of the first conduit system 50a. FIG. 4 is a timing chart illustrating two cases of changes of the M/C pressure and the W/C pressure over the time from an initial start of the braking operation when the brake control of the embodiment is executed and when the brake control of the embodiment is not executed as is the case with the known art. The brake operation in the emergency situation and the normal braking operation will be described below in accordance with FIGS. 2, 3 and 4.

The brake control process for the brake control in the emergency situation illustrated in FIG. 2 is executed at the ECU 70 every predetermined operational period when an ignition switch (not illustrated) is switched from OFF to ON. The ECU 70 executes an input process at Step 100. In Step 100, the ECU 70 inputs calculation value that is used for inputting the detection signals of each of the sensors and the like and for controlling the current supply to the motor 60. Specifically, for example, the detection signals of the M/C pressure sensors 75, the W/C pressure sensors 76, 77, 78 and 79, and the stop light switch 80 are inputted to the ECU 70.

In Step 105, the ECU 70 determines whether or not the braking operation is executed based on whether the stop light switch 80 is turned on or not. The ECU 70 determines that the braking operation is executed when the stop light switch 80 is turned on. The brake control in the emergency situation may be necessary only when the braking operation is executed, hence, when the ECU 70 determines that the braking operation is executed, the ECU 70 proceeds to Step 110.

In Step 110, the ECU 70 determines whether an emergency brake flag is turned on or not. The emergency brake flag is set when the ECU 70 determines that the driver requires the emergency stop, in other words, when the ECU 70 determines the brake control for the emergency stop is needed in Step 120. Further, the emergency brake flag is provided within a memory (not illustrated) of the ECU 70. When the braking operation has just started, the ECU 70 determines that there is no need for the brake control in the emergency situation to be executed in Step 110, and then the ECU 70 proceeds to Step 115.

In Step 115, the ECU 70 calculates a gradient of the M/C pressure dPMC (hereinafter, referred to as the M/C pressure gradient dPMC) based on a M/C pressure MPC inputted to the ECU 70 in Step 100. The M/C pressure gradient dPMC indicates a difference between the M/C pressure calculated in the present calculation cycle and the M/C pressure calculated in the previous calculation cycle. Then, the ECU 70 proceeds to Step 120 in which the ECU 70 determines whether or not the M/C pressure PMC is larger than a first threshold, and whether or not the M/C pressure gradient dPMC is larger than a second threshold. When the driver depresses the brake pedal 11 firmly in order to generate a larger braking force, the M/C pressure PMC becomes larger than the first threshold. On the other hand, when the driver depresses the brake pedal 11 quickly, which indicates that the driver needs to stop the vehicle urgently or decrease the speed of the vehicle urgently, the M/C pressure gradient dPMC becomes larger than the second threshold. Hence, when the M/C pressure PMC is larger than the first threshold and the M/C pressure gradient dPMC is larger than the second threshold, the ECU 70 determines that the driver may require the brake control in the emergency situation. When the ECU 70 determines that the M/C pressure PMC is larger than the first threshold and the M/C pressure gradient dPMC is larger than the second threshold in Step 120 (determining means), the ECU 70 proceeds to Step 125. Then, the ECU 70 sets the emergency brake flag in Step 125.

Then the ECU 70 proceeds to Step 130 and determines whether or not a pressure difference valve closing request flag is set. The pressure difference valve closing request flag is set when the ECU 70 determines to execute a brake assist control, in other words, the pressure difference valve closing request flag indicates a request to control the first and second pressure difference control valves 16 and 36 to be in the interrupting state. Specifically, in Step 135, the ECU 70 determines whether or not at least one of the W/C pressure values calculated on the basis of the detection signals of the W/C pressure sensors 76, 77, 78 and 79 is larger than a value calculated by subtracting a predetermined value from a M/C pressure value calculated in the present calculation cycle. The W/C pressure value corresponds to the W/C pressure of each of the W/Cs 14, 15, 34 and 35, and the M/C pressure value corresponds to the M/C pressure. Hence, when the ECU 70 determines that the driver requires the brake control in the emergency situation, the ECU 70 executes the brake assist control. The brake control in the emergency situation includes the determining step of the ECU 70 determining to execute the brake control in the emergency situation and the brake assist control. However, when an increase of the W/C pressure follows an increase of the M/C pressure in a pressure increasing process before the W/C pressure is increased so as to exceed the M/C pressure, the W/C pressure does not need to be rapidly increased, but when the increase of the W/C pressure does not follow the increase of the M/C pressure in the transitional process, the W/C pressure needs to be rapidly increased.

When the ECU 70 determines that at least one of the W/C pressure value is larger than the value calculated by subtracting the predetermined value from the M/C pressure value calculated in the present calculation cycle in Step 135, the ECU 70 proceeds to Step 140. Then, the ECU 70 sets the pressure difference control valve closing request flag in Step 140. Then, the ECU 70 proceeds to Step 145, and the ECU 70 turns on current supply to the first and the second pressure difference control valves 16 and 36 in Step 145. When the ECU 70 turns on the current supply to the first and the second pressure difference control valves 16 and 36, current necessary for the first and the second pressure difference control valves 16 and 36 to be in the interrupting states will be supplied. Then, the ECU 70 supplies the current to the open/close control valves 24 and 44 in Step 150 in order to control the open/close control valves 24 and 44 to be in the fluid communicating states. Further, the ECU 70 turns on a motor relay (not illustrated) in Step 155 in order to supply the current to the motor 60. Steps 140, 145 and 155 correspond to a first control means.

In a case where the current is supplied to the first and the second pressure difference control valves 16 and 36 and, to the open/close control valves 24 and 44 and to the motor 60, because the first and the second pressure difference control valves 16 and 36 are controlled to be in the pressure difference generating states, the brake fluid is supplied to each of the W/Cs 14, 15, 34 and 35 from the M/C 13 through routes R2 and R3. The route R2 goes through the pressure increasing valve 16a, and the route R3 goes through the pump 19. Similarly, the route R2 goes through the pressure increasing valve 36a, and the route R3 goes through the pump 39.

On the other hand, when the increase of the W/C pressure does not follow the increase of the M/C pressure in the previous pressure increasing process before the W/C pressures of the W/Cs 14, 15, 34 and 35 exceeds the M/C pressure, the ECU 70 determines that the at least one of the W/C pressures value calculated on the basis of the detection signals of the W/C pressure sensors 76, 77, 78 and 79 is not larger than the value calculated by subtracting the predetermined value from the M/C pressure value. In this case, the increasing speed of the W/C pressure does not follow the increasing speed of the M/C pressure. Hence, the W/C pressure needs to be rapidly increased. Therefore, when at least one of the W/C pressures values of the W/Cs 14, 15, 34 and 35 is smaller than the value calculated by subtracting the predetermined value from the M/C pressure value, the ECU 70 determines that the W/C pressures are not sufficiently increased, and then the ECU 70 proceeds to Step 160. In Step 160, the ECU 70 turns off the current supply to the first and the second pressure difference control valves 16 and 36. Then, the ECU 70 turns on the current supply to the open/close control valves 24 and 44 in Step 150 in order to control the open/close control valves 24 and 44 to be in the fluid communicating states. Further, the ECU 70 turns on the motor relay (not illustrated) in order to supply the current to the motor 60 in Step 155. Steps 160 and 155 correspond to a second control means.

In this state, when the first pressure difference control valve 16 is controlled to be in the fluid communicating state, the brake fluid is supplied to each of the W/Cs 14 and 15, which are connected to the M/C 13 through the first conduit system 50a, from the M/C 13 via a route R1 in addition to the route R2 and the route R3. Similarly, when the second pressure difference control valve 36 is controlled to be in the fluid communicating state, the brake fluid is supplied to each of the W/Cs 34 and 35, which are connected to the M/C 13 through the second conduit system 50b, from the M/C 13 via the route R1 in addition to the routes R2 and R3. Each of the routes R1 goes through each of the first and the second pressure difference control valves 16 and 36, each of the routes R2 goes through each of the pressure increasing valves 16a and 36a, and each of the routes R3 goes through each of the pumps 19 and 39.

When the braking operation is completed, the ECU 70 determines that the braking operation has not been conducted in Step 105, and then the ECU 70 proceeds to Step 165. In Step 165, the ECU 70 unsets the emergency brake flag, and the ECU 70 unsets the pressure difference control valve closing request flag in 170. Further, the ECU 70 turns off the current supply to the first and the second pressure difference control valves 16 and 36 in Step 180, and the ECU 70 turns off the motor relay in Step 185 in order to turn off the current supply to the motor 60.

Similarly, when the ECU 70 determines that the driver does not require the brake control in the emergency situation in Step 120, the ECU 70 proceeds to Steps 175. In Step 175, the ECU 70 turns off the current supply to the first and the second pressure difference control valves 16 and 36. Then, the ECU 70 proceeds to Step 180. The ECU 70 turns off the current supply to the open/close control valves 24 and 44 in Step 180. Further, the ECU 70 proceeds to step 180. The ECU 70 turns off the motor relay in Step 180. The above-mentioned processes, which are executed after the ECU 70 determines that the braking operation has not been conducted in step 105 or after the ECU 70 determines that the brake control in the emergency situation is not required in step 120, correspond to the processes executed for the normal braking operation. In the case where the brake control for the normal braking operation is executed, each of the control valves 16, 17, 18, 21, 22, 24, 36, 37, 38, 41, 42 and 44 remain in the states illustrated in FIG. 1. Specifically, each of the control valves 17, 18, 21, 22, 24, 37, 38, 42, 42 and 44 remain to be in the fluid communicating states, and the pressure difference control valves 16 and 36 remain to be in the interrupting states. Hence, the M/C pressure is directly transmitted to the W/Cs 14, 15, 34 and 35 without pressure control. As a result, level of the W/C pressure generated at each of the W/Cs 14, 15, 34 and 35 becomes equal to the level of the M/C pressure.

The brake control in the emergency situation will be described in detail below in accordance with a time chart illustrated in FIG. 4. The brake control in the emergency situation includes the determining step of the ECU 70 determining to execute the brake control in the emergency situation and the brake assist control. When the above-mentioned brake control processes for the brake control in the emergency situation is executed, firstly, the brake control for the normal braking operation is executed during a time period T1 in FIG. 4 immediately after the braking operation has just conducted by the driver, in other words, the brake control for the normal braking operation is being executed until the ECU 70 determines that the driver requires the brake control in the emergency situation. While the brake control for the normal braking operation is being executed, the current supply to the first and the second pressure difference control valves 16 and 36, and to the open/close control valves 24 and 44 are turned off, and further, the motor relay is also turned off. Hence, the brake fluid is supplied to each of the W/Cs 14 and 15 from the M/C 13 via the routes R1 and R2 in FIG. 3, similarly, the brake fluid is supplied to each of the W/Cs 34 and 35 from the M/C 13 via the routes R1 and R2.

The brake assist control in the emergency situation is executed during a time period T2 between a time when the ECU 70 determines that the driver requires the brake control in the emergency situation and a time when the W/C pressure is increased sufficiently. For example, one of the W/C pressures of the W/Cs 14, 15, 45 and 35 during the time period T2 is lower than the value calculated by subtracting the predetermined value from the M/C pressure value. Hence, the ECU 70 supplies the current to the open/close control valves 24 and 44 and turns on the motor relay. However, the current supply to the first and the second pressure difference control vales 16 and 36 remain to be turned off. Hence, the brake fluid is supplied to each of the W/Cs 14, 15, 34 and 35 from the M/C 13 via all the routes R1, R2 and R3 in FIG. 3. On the other hand, in the known art, the current remained to be supplied to the first and the second pressure difference control valves 16 and 36 during the transitional period T2. Hence, according to the known art, the brake fluid is supplied to each of the W/Cs 14, 15 34 and 35 from the M/C 13 via routes corresponding to the routes R2 and R3 in FIG. 3.

The current is supplied to the first and the second pressure difference control valves 16 and 36 during a time period T3 when at least one of the W/C pressures becomes larger than the value calculated by subtracting the predetermined value from the M/C pressure value. Then, when the W/C pressures of the W/Cs 14, and 15 become equal to or more than the M/C pressure, the brake fluid is supplied to each of the W/Cs 14 and 15, from the M/C 13 via only the route R 3, and similarly, when the W/C pressure of the W/Cs 34 and 35 become equal to or more than the M/C pressure, the brake fluid is supplied to the W/Cs 34 and 35 from the M/C 13 only through the route R3. Additionally, FIG. 4 illustrates a case where the predetermined value, which is subtracted from the M/C pressure value, is set to zero, as an example.

According to the brake control system 1 of the embodiment, the brake fluid is supplied to each of the W/Cs 14, 15, 34 and 35 from the M/C 13 via all the routes R1, R2 and R3 in FIG. 3, the drive of the first and the second pressure difference control valves 16 and 36 is delayed for the time period T2 after the pumps 19 and 36 are driven by not supplying the current to the first and the second pressure difference control valves 16 and 36 immediately after the brake control in the emergency situation is executed. Hence, the W/C pressures of the W/Cs 14, 15, 34 and 35 are rapidly increased so as to follow the increase of the M/C pressure. Specifically, the brake fluid is supplied to each of the W/Cs 14, 15, 34 and 35 from the M/C 13 through the route R1 with a very low flow resistance when the first and the second pressure difference control valves 16 and 36 are controlled to be in the fluid communicating states. Hence, the W/C pressures are rapidly increased.

In a case where the M/C pressure is decreased due to insufficient pressure being applied to the brake pedal 11 while, for example, a female driver operates the brake operation in the emergency situation will be described below. Even when the depressing force generated by the driver is not sufficient, but when the driver depresses the brake pedal 11 quickly, the ECU 70 determines to execute the brake control in the emergency situation. In this case, the ECU 70 executes the above-mentioned processes until the ECU 70 determines that the driver requires the brake control in the emergency situation when the driver depresses the brake pedal 11 quickly. Then, when the M/C pressure is decreasing during the time period T2, the timing when at least one of the W/C pressure values becomes larger than the value calculated by subtracting the predetermined value from the M/C pressure value is advanced comparing to a case where brake control for the normal braking operation is executed. However, even in that case, the W/C pressures of the W/Cs 14, 15, 34 and 35 are rapidly increased by switching the pressure difference control valves 16 and 36 from OFF to ON when one of the W/C pressure values becomes larger than the value calculated by subtracting the predetermined value from the M/C pressure value.

### Second Embodiment

A second embodiment according to the present invention will be described below. In the second embodiment, the brake control system 1 executing another brake assist control in the emergency situation will be described below. The brake control system 1 of the second embodiment basically executes the same processes for the brake control in the emergency situation. Hence, only different parts of the brake control processes for the brake control in the emergency situation will be described below.

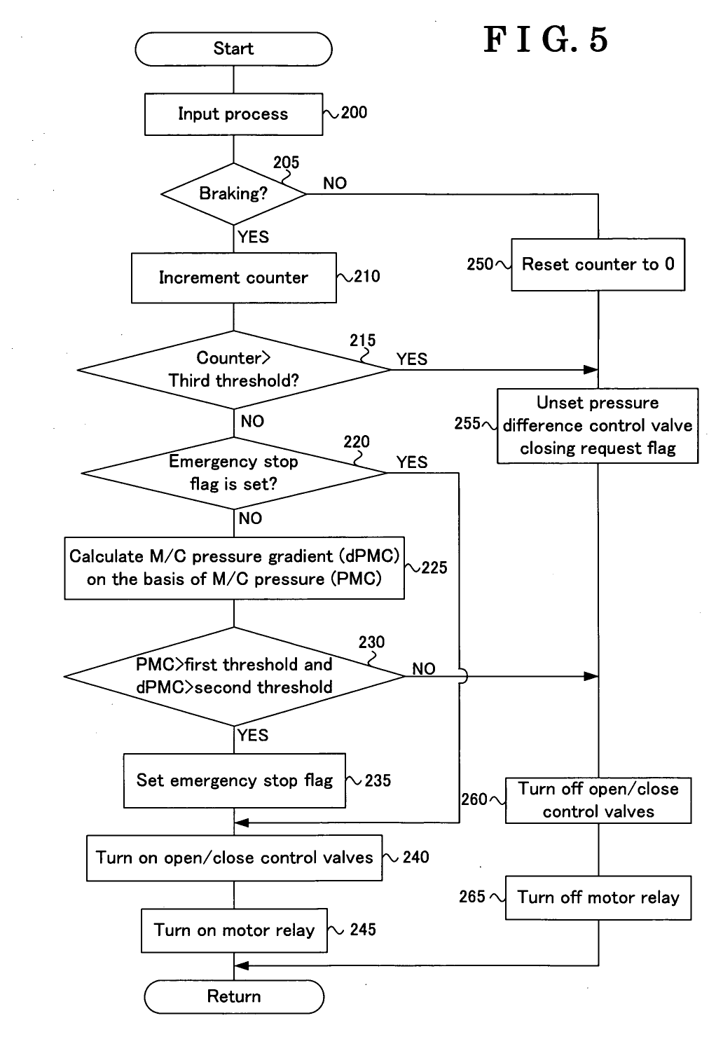

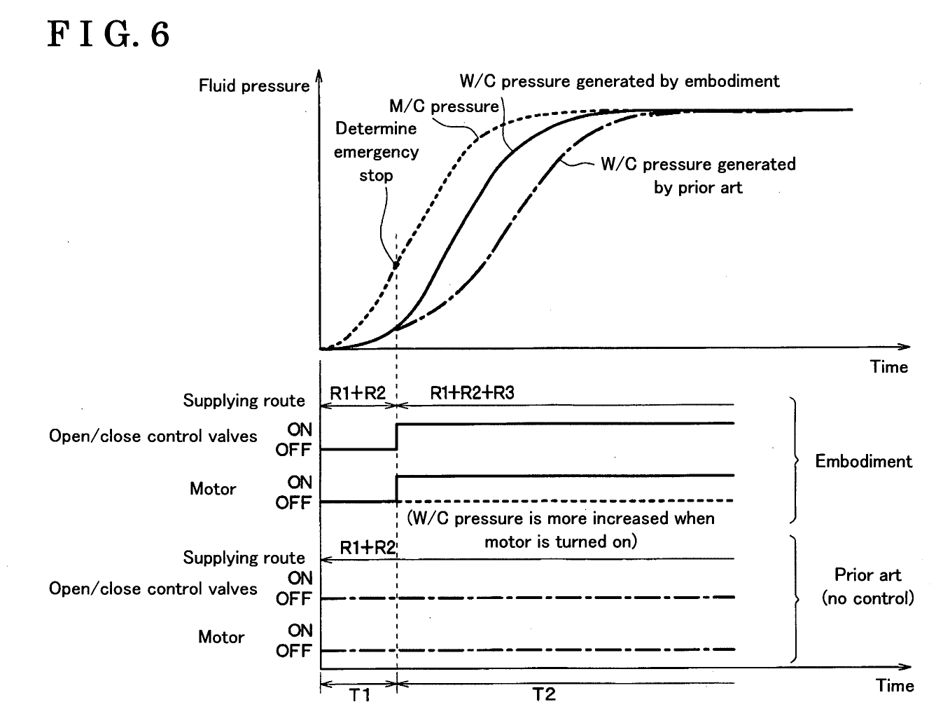

FIG. 5 is a flowchart illustrating the brake control processes for the brake control in the emergency state executed by the ECU 70 of the second embodiment. FIG. 6 is a timing chart illustrating two cases of changes of the M/C pressure and one of the W/C pressures of the W/Cs 14, 15 34 and 35 over the time from an initial start of the brake control of the embodiment being executed and when the brake control of the embodiment is not executed as is the case with the known art. The operations of the brake controls in the emergency situation and for the normal braking operation will be described below in accordance with FIGS. 5 and 6.

The ECU 70 executes the same processes as Steps 100 and 105 of FIG. 2 in Steps 200 and 205. Then, when the ECU 70 determines that the braking operation executed by the driver in step 205, the ECU 70 proceeds to Step 210.

In Step 210, a counter is incremented. Further, in Step 215, the ECU 70 determines whether or not the counter exceeds a third threshold. The counter is used for timing an elapsed time since the ECU 70 has determined that the braking operation is conducted. The brake control in the emergency situation may be required immediately after the braking operation has started. However, the brake control in the emergency situation is not necessary after the W/C pressures of the W/Cs 14, 15, 34 and 35 are sufficiently increased or when the ECU 70 determines that the driver does not require the brake control in the emergency situation. Hence, the ECU 70 determines whether or not a predetermined time has passed since the braking operation has started by determining whether or not the counter exceeds the third threshold. A period until the counter exceeds the third threshold is regarded as a period where the braking control in the emergency situation needs to be exceeded. Further, the counter is incremented every calculation cycle, hence, a value calculated by multiplying a number of the calculation cycle (counter value) by the third threshold corresponds to a period (predetermined time) necessary for executing the brake control in the emergency situation.

When the ECU 70 determines that the counter does not exceed the third threshold in Step 215, the ECU 70 executes the same processes as Steps 110, 115 and 120 of FIG. 2 in Steps 220, 225 and 235 of FIG. 5. In a case where the ECU 70 determines that the emergency brake flag is not set in Step 220 and then the ECU 70 determines that the M/C pressure PMC is larger than the first threshold and the M/C pressure gradient dPMC is larger than the second threshold in Step 230 (determining means), and in a case where the ECU 70 determines that the emergency brake flag is set in Step 220, the ECU 70 proceeds to Step 240. Then, the ECU 70 executes the same processes as Steps 150 and 155 of FIG. 2 in Steps 240 and 245 in order to turn on the current supply to the open/close control valves 24 and 44 and to turn the motor relay on. Steps 240 and 245 correspond to a control means.

In the case where the current supplies to the open/close control valves 24 and 44 are turned on and the motor relay is turned on, the state of the first and the second pressure differential control valves 16 and 36 remain to be unchanged from the states established when the brake control for the normal braking operation is executed, in other words, the first and the second control valves 16 and 35 remain to be in the fluid communicating states until the ECU 70 executes the process of Step 245 in order to supply current to the open/close control valves 24 and 44. Hence, the brake fluid is supplied to each of the W/Cs 14, 15, 34 and 35 from the M/C 13 via all of the routes R1, R2 and R3 illustrated in FIG. 3 until the ECU 70 executes the process of Step 245.

After the braking operation is completed, the ECU 70 determines that the braking operation has not been conducted in step 205, and then the ECU 70 resets the counter to zero in Step 250. Further, the ECU 70 unsets the emergency brake flag in Step 255. Moreover, the ECU 70 turns off the current supply to the open/close control valves 24 and 44 in Step 260, and the ECU 70 turns off the motor relay in Step 265 in order to turn off the current supply to the motor 60.

Similarly, in a case where the ECU 70 determines that the brake control in the emergency situation is not required in Step 230, the ECU 70 proceeds to Step 260. The ECU 70 turns off the current supply to the open/close control valves 24 and 44 in Step 260, and then the ECU 70 proceeds to Step 265. In 265, the ECU 70 turns the motor relay off. This case corresponds to a case where the brake control for normal braking operation is executed. In this case, the states of the control valves 16, 17, 18, 21, 22, 24, 36, 37, 38 41, 42 and 44 remain to be in the states illustrated in FIG. 1. Specifically, the control valves 17, 18, 21, 22, 24, 37, 38, 41, 42 and 44 remain to be in the fluid communicating state, and the pressure difference control valves 16 and 36 remain to be in the interrupting state. Hence, the M/C pressure is directly transmitted to each of the W/Cs 14, 15, 34 and 35. As a result, the level of each of the W/C pressures corresponds to the level of the M/C pressure.

In the case where the above-mentioned processes for the brake control in the emergency situation is executed, the ECU 70 executes the brake control for the normal braking operation during the time period T1 in FIG. 6. In other words, the ECU 70 executes the brake control for normal braking operation until the ECU 70 determines that the driver requires the brake control in the emergency situation. During the time period T1, the current supply to the open/close control valves 24 and 44 remain to be turned off, and the motor relay also remains turned off. Hence, the brake fluid is supplied to each of the W/Cs 14, 15, 34 and 35 from the M/C 13 via the routes R1 and R2 illustrated in FIG. 3.

After the ECU 70 determines that the brake control in the emergency situation is required, the ECU 70 executes the brake assist control in the emergency situation during the time period T2 until the W/C pressures of the W/Cs 14, 15, 34 and 35 are sufficiently increased. Until the W/C pressures are sufficiently increased during the time period T2, the current supply to the open/close control valves 24 and 44 remains turned on, and the motor relay also remains turned on. During the time period T2, the current supply to each of the first and the second pressure difference control valves 16 and 36 remains to be turned off. Hence, the brake fluid is supplied to each of the W/Cs 14, 15, 34 and 35 from the M/C 13 via all the routes R1, R2 and R3 illustrated in FIG. 3. On the other hand, the brake control system of the known art does not supply the current to the motor 60 for the transitional period T2, hence, the brake fluid is supplied to each of the W/Cs 14, 15, 34 and 35 from the M/C 13 via the routes R1 and R2 illustrated in FIG. 3. Then, the brake control system of the known art terminates the brake assist control in the emergency situation and executes the brake control for the normal braking operation when the counter exceeds the third threshold.

As mentioned above, according to the brake control system 1 of the second embodiment, the brake fluid is supplied to each of the W/Cs 14, 15, 34 and 35 from the M/C 13 via all the routes R1, R2 and R3 illustrated in FIG. 3 without executing the brake assist control in the emergency situation immediately after the brake control has been executed by the driver. Hence, the W/C pressures are rapidly increased so as to follow the increase of the M/C pressure.

Step 245 of FIG. 5 is put in round brackets, because the motor relay is not necessarily turned on. In the case of the second embodiment where the current is supplied to the open/close control valves 24 and 44 when the brake control in the emergency situation is required, the M/C 13 and each of the reservoirs 20 and 40 are in a communication state via the conduits D and H. However, the brake fluid stored in the reservoirs 20 and 40 may be supplied to each of the W/Cs 14, 15, 34 and 35 through intervals formed at the pumps 19 and 39 without actuating the pumps 19 and 39 to suck and discharge the brake fluid. Therefore, the brake fluid is supplied to each of the W/Cs 14, 15, 34 and 35 from the M/C 13 via the route R3 illustrated in FIG. 3, although the amount of the brake fluid supplied to the W/Cs 13, 14, 34 and 35 is smaller than the amount of the brake fluid supplied thereto when the pumps 19 and 39 are driven. Hence, according to the second embodiment, the W/C pressures of the W/Cs 14, 15, 34 and 35 are more rapidly increased so as to follow the increase of the M/C pressure without turning on the motor relay, compared to the brake control system of the known art.

### Third Embodiment

A third embodiment of the present invention will be described below. In the third embodiment, the brake control system 1 is basically configured as the same as the first embodiment, and the brake control system 1 of the third embodiment basically executes the same brake control in the emergency situation. Therefore, only the different and modified configuration and processes of the control system 1 will be described below.

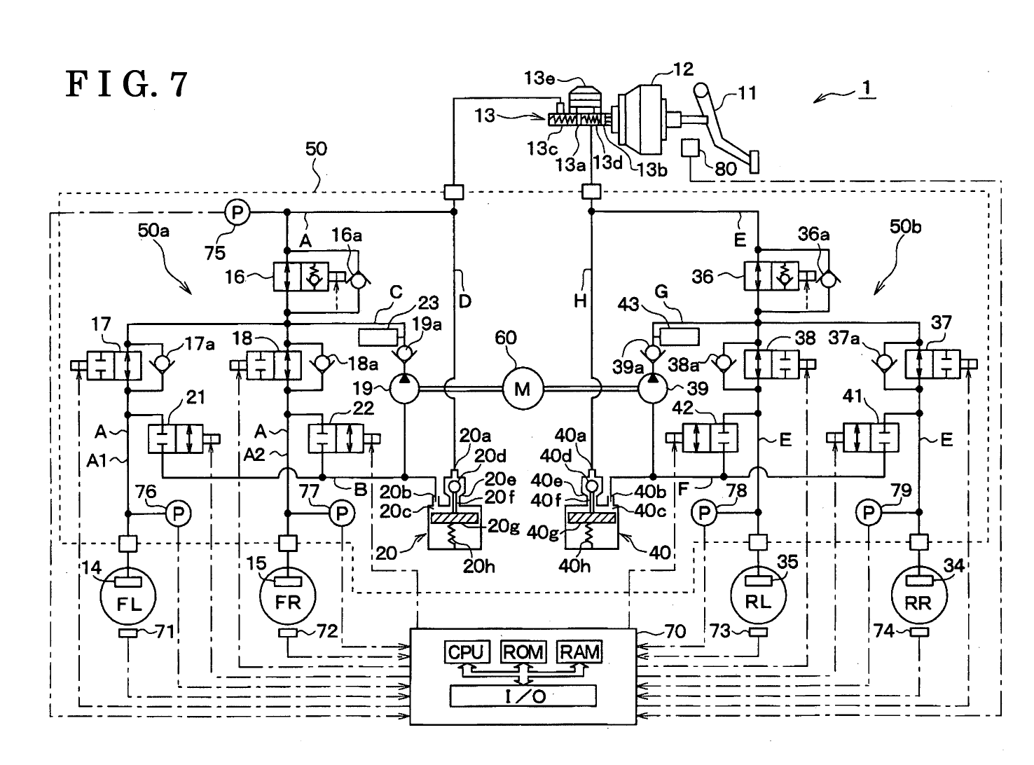

FIG. 7 illustrates the entire configuration of the brake control system 1 of the third embodiment. As illustrated in FIG. 7, each of the reservoirs 20 and 40 of the first embodiment is configured with a pressure modulating reservoir. Further, in the brake control system 1 of the third embodiment, the open/close control valves 24 and 44 are eliminated. In short, the control system 1 of the first embodiment is configured to include twelve control valves, on the other hand, the control system 1 of the third embodiment is configured to include ten control valves.

The pressure modulating reservoir 20 includes a reservoir chamber 20c, a reservoir hole 20a and a reservoir hole 20b. The pressure modulating reservoir 20 receives the brake fluid from the M/C 13 through the reservoir holes 20a through which the pressure modulating reservoir 20 is connected to the conduit D. The pressure modulating reservoir 20 receives the brake fluid from the W/Cs 14 and 15 through the reservoir hole 20b through which the pressure modulating reservoir 20 is connected to the conduits B and C. Further, the pressure modulating reservoir 20 supplies the brake fluid to the pump 19 through an inlet of the pump 19 through the reservoir hole 20b. The brake fluid flows in/out of the reservoir chamber 20c through the reservoir holes 20a and 20b. A ball valve 20d is arranged at a position between the reservoir hole 20a and the reservoir chamber 20c so as to be positioned close to the reservoir hole 20a. An individual rod 20f is provided at the ball valve 20d. The rod 20f makes a movement with a certain stroke in order to move the ball valve 20d up and down.

Further, a piston 20g and a spring 20h are provided within the reservoir chamber 20c. The piston 20g is moved up and down in conjunction with movement of the rod 20f. The spring 20h generates force for pressing the piston 20g towards the ball valve 20d in order to discharge the brake fluid stored in the reservoir chamber 20c.

The pressure modulating reservoir 20 is configured so that the brake fluid is not flown thereinto by the ball valve 20d being seated on a valve seat 20e when a predetermined amount of the brake fluid is stored within the pressure modulating reservoir 20. Hence, the brake fluid is not flow into the pressure modulating reservoir 20 over a suction capacity of the pump 19. As a result, the pump 19 is prevented from receiving high pressure.

The pressure modulating reservoir 40 is configured to be the same as the pressure modulating reservoir 20. Components and functions of 40a, 40b, 40c, 40d, 40e, 40f, 40g and 40h of the pressure modulating reservoir 40 correspond to the components and functions of 20a, 20b, 20c, 20d, 20e, 20f, 20g and 40h of the pressure modulating reservoir 20 respectively.

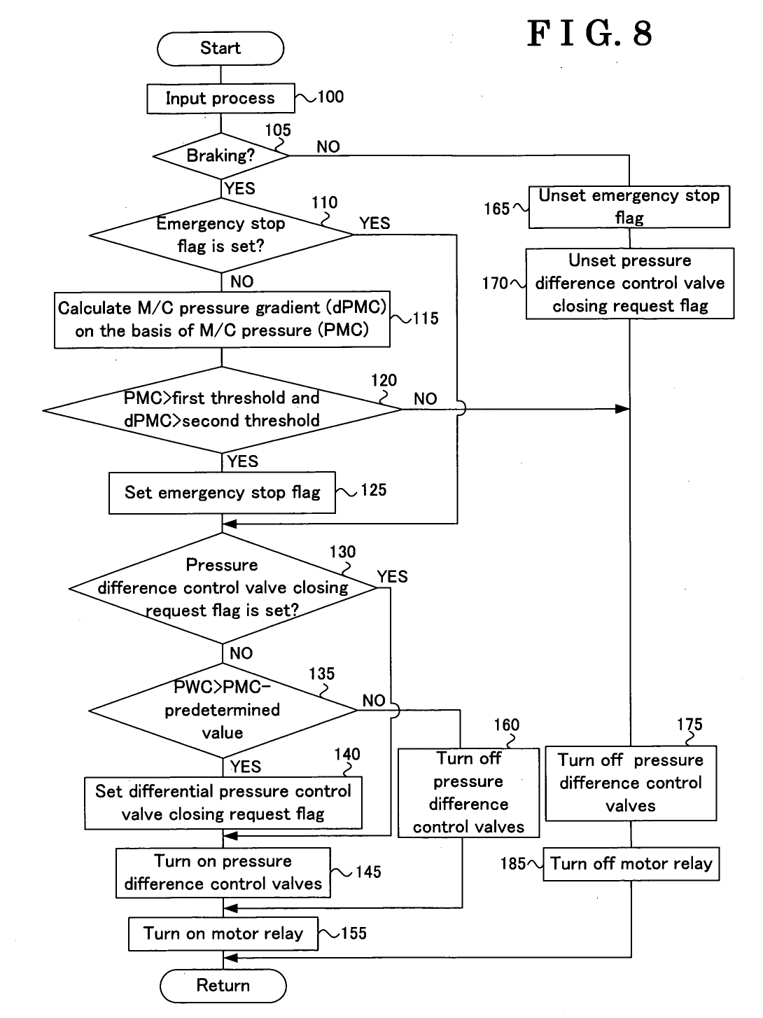

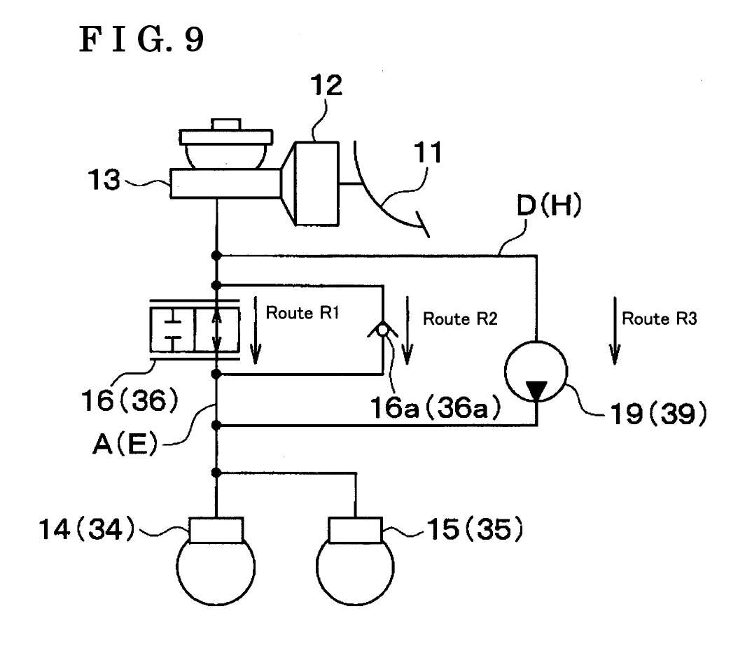

FIG. 8 is a flowchart illustrating a process for the brake control in the emergency situation executed at the ECU 70 of the third embodiment. FIG. 9 is a simplified diagram of the conduit configuration of the brake control system 1 for describing the routes of the brake fluid being supplied when the driver operates the brake operation in the emergency situation or the normal braking operation.

The brake control in the emergency situation of the third embodiment is achieved with a series of processes illustrated in FIG. 8, in which the processes of Steps 150 and 180 in FIG. 2 of the first embodiment are skipped. Step 120 in FIG. 8 corresponds to a determining means, and Step 155 in FIG. 8 corresponds to a control means.

The ECU 70 basically executes the brake assist control in the emergency situation. However, specifically, the first and the second pressure difference control valves 16 and 36 remain to be in the fluid communicating state until at least one of the W/C pressure values exceeds the value calculated by subtracting the predetermined value from the M/C pressure value. Under this condition, the brake fluid is supplied to the W/Cs 14, 15, 34 and 35 through the routes R1 and R2, and the M/C 13 and each of the pressure modulating reservoirs 20 and 40 are in the communicating state through the conduits D and H. Therefore, the route R3 illustrated in FIG. 9 is also turned to be in the fluid communicating state by driving the pumps 19 and 39. Hence, the brake fluid is supplied to each of the W/Cs 14, 15, 34 and 35 from the M/C 13 via all the routes R1, R2 and R3. As a result, the W/C pressures are rapidly increased so as to follow the increase of the M/C pressure. When at least one of the W/C pressure values exceeds the value calculated by subtracting the predetermined value from the M/C pressure value, the first and the second pressure difference control valves 16 and 36 are turned to be in the interrupting states. Under this condition, the brake fluid is supplied to each of the W/Cs 14, 15, 34 and 35 from the M/C 13 via the route R3, or via the routes R2 and R3.

Further, because the first and the second pressure difference control valves 16 and 36 remain to be in the fluid communicating states, when the M/C pressure is generated by the driver depressing the brake pedal 11 to operate the normal braking operation, the brake fluid is supplied to each of the W/Cs 14, 15, 3 and 35 from the M/C 13 through the routes R1 and R2 in FIG. 9.

In the case where the above-mentioned brake control process in the emergency situation is executed, the brake control system 1 of the third embodiment executes the same operations as the brake control system 1 of the first embodiment executes. Hence, the brake control system 1 of the third embodiment achieves the same effects and results as the brake control system 1 of the first embodiment achieves.

### Fourth Embodiment

A fourth embodiment of the present invention will be described below. In the fourth embodiment, the brake control system 1 executes another brake control in emergency situation. The brake control system 1 of the fourth embodiment basically executes the same brake control in the emergency situation as the brake control system 1 of the second embodiment. Hence, only the different and modified processes will be described below.

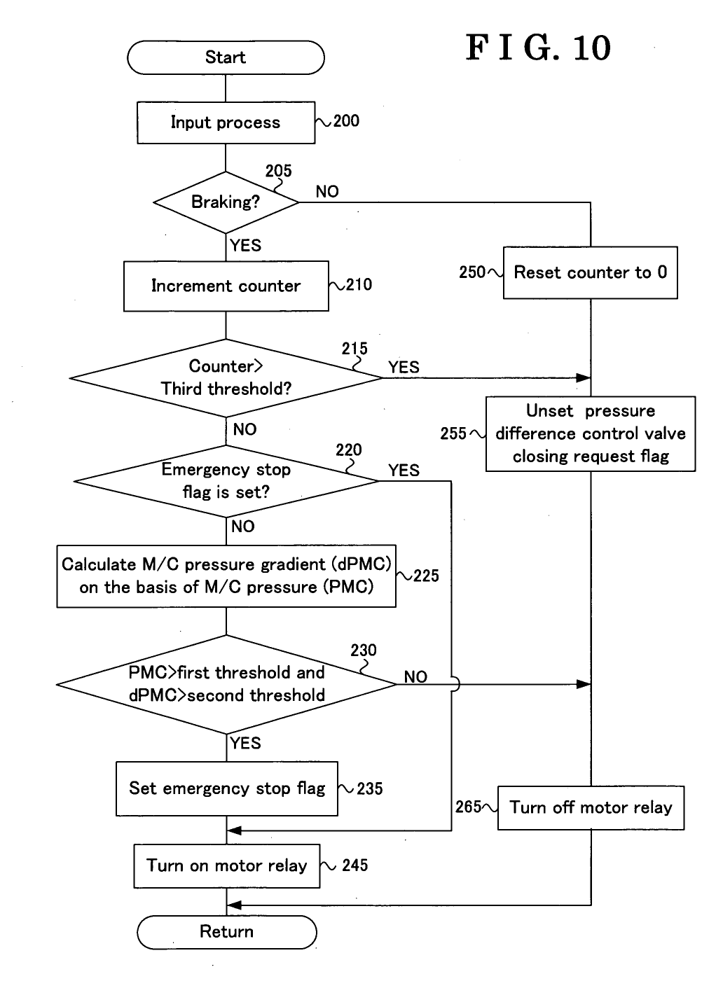

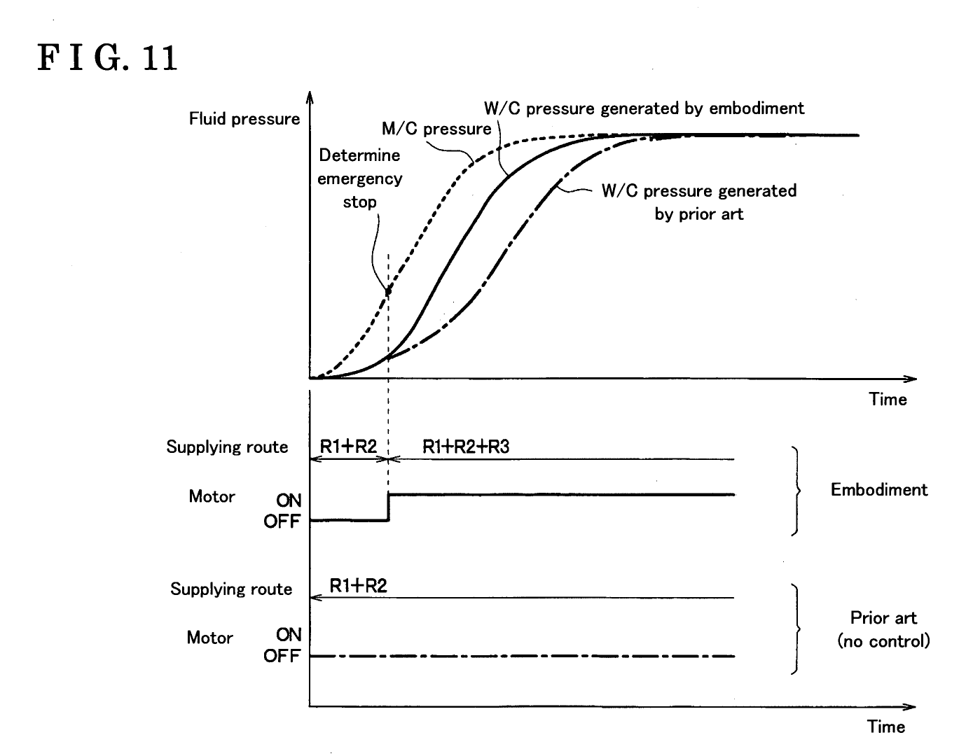

FIG. 10 is a flowchart illustrating the brake control process in the emergency situation executed by the ECU 70 of the fourth embodiment. FIG. 11 is a timing chart illustrating two cases of changes of the M/C pressure and one of the W/C pressure over the time from an initial start of the braking operation when the brake control of the embodiment is executed and when the brake control of the embodiment is not executed as is the case with the known art.

The brake control in the emergency situation of the fourth embodiment is achieved with the series of processes illustrated in FIG. 10, in which the processes of Steps 240 and 260 in FIG. 5 of the second embodiment are skipped.

Specifically, the motor relay remains turned on until the W/C pressures are sufficiently increased when the brake operation in emergency situation is executed. Further, the current supply to the first and the second pressure difference control valves 16 and 36 remain to be turned off. Hence, the brake fluid is supplied to each of the W/Cs 14, 15, 34 and 35 from the M/C 13 through all the routes R1, R2 and R3 in FIG. 9. Then, when the counter exceeds the third threshold, the ECU 70 completes the brake control in the emergency situation, and the ECU 70 executes the brake control for the normal braking operation.

Additionally, because the first and the second pressure difference control valves 16 and 36 are controlled to be in the fluid communicating states, when the M/C pressure is generated by the driver depressing the brake pedal 11, the brake fluid is supplied to each of the W/Cs 14, 15, 34 and 35 from the M/C 13 through the routes R1 and R2 in FIG. 9.

When the above-mentioned brake control in the emergency situation is executed, the brake control system 1 of the fourth embodiment executes the same operation as the brake control system 1 of the second embodiment. In other words, the brake control system 1 of the fourth embodiment executes the same operation illustrated in the timing chart of FIG. 6. Hence, the brake control system 1 of the fourth embodiment achieves the same effects and the results as the brake control system 1 of the second embodiment.

### Other Embodiments

In each of the above-mentioned embodiments, the brake control system 1 having ten or twelve control valves is described as a representative example. However, the number of the control valves included in the brake control system 1 is not limited to ten or twelve, as long as the brake control system 1 includes the first and the second pressure difference control valves 16 and 36, as long as the pump 19 discharges the brake fluid to a point between the first pressure difference control valve 16 and the W/Cs 14 and 15, and further, as long as the pump 39 discharges the brake fluid to a point between the second pressure difference control valve 36 and the W/Cs 34 and 35.

Further, in the above-mentioned embodiments, the M/C pressure is detected on the basis of the detection signal outputted from the M/C pressure sensor 75, and each of the W/C pressures is detected on the basis of the detection signal of each of the W/C pressure sensors 76, 77, 78 and 79, as an example. However, the M/C pressure and the W/C pressures may be calculated by using other well-known methods, for example, the M/C pressure may be calculated on the basis of amount of strokes of the brake pedal 11 or the depressing force applied to the brake pedal 11, and the W/C pressures may be calculated on the basis of the M/C pressure and a current value of the current supplied to the first and the second pressure difference control valves 16 and 36, and the pumps 19 and 39.

Additionally, each of steps illustrated in each drawing corresponds to a means for executing each process.

Manners in which the brake fluid is transmitted, when the driver depresses the brake pedal 11 brakes firmly and quickly to stop the vehicle urgently or decrease the speed of the vehicle urgently, are examined in above-mentioned embodiments.

In the brake control system of the known art, the pressure difference control valve remains to be in the pressure difference generating state immediately after the known brake control system determines that the brake control in the emergency situation is required. Therefore, the brake fluid is supplied to the W/Cs from the M/C via the route that corresponds to the route R3 of the embodiment and that goes through the pressure increasing valve provided in parallel to the first pressure difference control valve and via the route that corresponds to the route R3 of the embodiments and that goes through the pump. However, in this case, a route that corresponds to the Route R1 of the embodiments and that goes through the pressure difference control valve is not utilized to supply the brake fluid to the W/Cs from the M/C. In other words, the brake control system of the known arts controls the pressure difference control valve to be in the pressure difference generating state immediately after the brake control system of the known art determines that the brake control in the emergency situation is required. Hence, a transitional period, which is needed for increasing the W/C pressure of each of the W/Cs because the pump is not driven immediately after the brake control system determines that the brake control in the emergency situation is required, is not considered in the brake control system of the known art. On the other hand, the brake control system 1 described in the above-mentioned embodiments increases the W/C pressure of each of the W/Cs 14, 15, 34 and 35 more rapidly by using the route R1 that goes through the pressure difference control valves 16 and 36.

The main conduits A and E and the auxiliary conduits D and H function as the brake fluid supplying conduits through witch the brake fluid is supplied to the W/Cs 14, 15, 34 and 35 from the M/C 13 by the brake control system 1 driving the pressure difference control valves 16 and 36 to be in the pressure difference generating state after the brake control system 1 drives the pump 19 and 39. Hence, the brake fluid is supplied to each of the W/Cs 14, 15, 34 and 35 from the M/C 13 though the route R1 that goes through the pressure difference control valves 16 and 36.

According to the first embodiment, the ECU 70 executes the process of Step 160 and then the process of Step 155, when the ECU 70 determines that the increase of the at least one of the W/C pressure does not follow the increase of the M/C pressure. The M/C pressure is detected by the M/C pressure sensor 75, and W/C pressure of each of the W/Cs 14, 15, 34 and 35 is detected by each of the W/C pressure sensors 76, 77, 78 and 79.

Accordingly, when the ECU 70 detects that the one of the W/C pressures of the W/Cs 14, 15, 34 and 35 does not follow the M/C pressure, the ECU 70 drives the pressure difference control valves 16 and 36 after the motor 19 and 39 are driven. Hence, more brake fluid is supplied to each of the W/Cs 14 and 15 from the M/C 13 through the conduit D, and similarly, more brake fluid is supped to each of the W/Cs 34 and 35 from the M/C 13 through the conduit H.

According to the first embodiment, the ECU 70 executes the processes of Step 140, 145 and 155 after the ECU 70 determines that the W/C pressure value, which corresponds to one of the W/C pressure, becomes equal to or more than the value calculated by subtracting the predetermined value from the M/C pressure value, which corresponds to the M/C pressure.

Accordingly, even in a case where the brake assist control is not executed, the conduits D and H are utilized for supplying the brake fluid to each of the W/Cs 14, 15, 34 and 35 from the M/C 13 when the ECU 70 determines to execute the brake control in the emergency situation. Hence, even if the brake assist control is not executed in the emergency situation, still, the brake control system 1 of the above-mentioned embodiment rapidly increases the W/C pressures of W/Cs 14, 15, 34 and 35 so as to follow the increase of the M/C pressure.

According to the second embodiment, the ECU 70 controls the open/close control valves 24 and 44 to be in the fluid communicating state in Step 240, and then the ECU 70 proceeds to Step 245. In Step 245, the ECU 70 drives the pumps 19 and 39 to discharge the brake fluid in order to supply the brake fluid to each of the wheel cylinders 14, 15, 34 and 35.

Accordingly, when the ECU 70 determines to execute the brake control in the emergency situation, the ECU 70 drives the pumps 19 and 39 in order to suck and discharge the brake fluid stored within the pressure modulating reservoirs 20 and 40, which are connected to the conduits D and H respectively. As a result, the brake fluid is supplied to each of the W/Cs 14, 15, 34 and 35. Hence, the auxiliary conduit D and H are also utilized to supply the brake fluid to the W/Cs 14, 15, 34 and 35 from the M/C 13. As a result, the brake control system 1 of the above-mentioned embodiment rapidly increases the W/C pressures of W/Cs 14, 15, 34 and 35 so as to follow the increase of the M/C pressure.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A brake control device for a vehicle for controlling a pressure difference control valve provided at a main conduit and a pump provided at an auxiliary conduit in order to control a flow of brake fluid supplied from a master cylinder to a wheel cylinder provided at each of plural wheels, the master cylinder and the wheel cylinder are connected by the main conduit and the auxiliary conduit, the brake control device for the vehicle comprising:
a determining means for determining whether or not to execute a brake control in an emergency situation;
a first control means for controlling the pressure difference control valve to be in a pressure difference generating state and for controlling the pump in order to supply the brake fluid between the pressure difference control valve and the wheel cylinder through the auxiliary conduit; and
a second control means for controlling the pressure difference control valve to be in a fluid communicating state, and for controlling the pump in order to supply the brake fluid between the pressure difference control valve and the wheel cylinder through the auxiliary conduit, wherein the second control means is executed before the first control means is executed when the first determining means determines to execute the brake control in the emergency situation.

2. The brake control device for the vehicle according to claim 1, wherein the second control means is executed when a wheel cylinder pressure does not follow a master cylinder pressure, the master cylinder pressure generated in the master cylinder and the wheel cylinder pressure generated at the wheel cylinder are detected by a detecting means.

3. The brake control device for the vehicle according to claim 2, wherein the first control means is executed when a wheel cylinder pressure value, which corresponds to the wheel cylinder pressure, detected by the detecting means becomes equal to or more than a value calculated by subtracting a predetermined value from a master cylinder pressure value, which corresponds to the master cylinder pressure.

4. A brake control device for a vehicle for controlling a pressure difference control valve provided at a main conduit and a pump provided at an auxiliary conduit in order to control a flow of brake fluid supplied from a master cylinder to a wheel cylinder provided at each of plural wheels, the master cylinder and the wheel cylinder are connected by the main conduit and the auxiliary conduit, the brake control device for the vehicle comprising:
a first determining means for determining whether or not to execute a brake control in an emergency situation; and
a control means for controlling the pressure difference control valve to be in a fluid communicating state and for controlling an open/close control valve, which is provided between the pump and the master cylinder, to be in the fluid communicating state on the auxiliary conduit, when the determining means determines to execute the brake control in the emergency situation.

5. The brake control device for the vehicle according to claim 4, wherein when the control means controls the open/close control valve to be in the fluid communicating state, the control means drives the pump to discharge the brake fluid in order to supply the brake fluid to the wheel cylinder.

6. A brake control device for a vehicle for controlling a pressure difference control valve provided at a main conduit and a pump provided at an auxiliary conduit in order to control a flow of brake fluid supplied from a master cylinder to a wheel cylinder provided at each of plural wheels, the master cylinder and the wheel cylinder are connected by the main conduit and the auxiliary conduit, the brake control device for the vehicle comprising:
a determining means for determining whether or not to execute a brake control in an emergency situation; and
a control means for driving the pump in order to suck and discharge the brake fluid stored within a pressure modulating reservoir connected to the auxiliary conduit, when the determining means determines to execute the brake control in the emergency situation.
